(19) United States
(12) Patent Application Publication
(10) Pub. No.: US 2006/0106191 A1
(43) Pub. Date: May 18, 2006

(54) Pet artificial aggregate for the preparation of lightened concrete

(76) Inventors: Salvatore Lo Presti, Palermo (IT); Enrico Martines, Palermo (IT)

Correspondence Address: YOUNG & THOMPSON, 745 SOUTH 23RD STREET, 2ND FLOOR, ARLINGTON, VA, 22202, US

(21) Appl. No.: 10/527,325

(22) PCT Filed: Sep. 8, 2003
(86) PCT No.: PCT/EP03/09958

§ 371 Date: Oct. 28, 2005

(30) Foreign Application Priority Data
Sep. 11, 2002 (IT) PA2002A000016

(51) Int. Cl. C08G 63/02; C08F 6/00

(52) U.S. Cl. 528/272; 528/502 R

(57) ABSTRACT

Lightweight artificial aggregate in sanded or non-sanded PET for the production of light or lightened structural and nonstructural concrete or materials for building industry, and a process for the preparation thereof.

The present invention provides a novel lightweight PET (polyethylenterephtalate) artificial aggregate for the production of lightened structural and non-structural concrete or materials for building industry, and a process for the preparation thereof.

### BACKGROUND OF THE INVENTION

According to the UNI normative, light or lightened concrete has an apparent volume mass of from 200 to 2000 Kg/m³, that is, lower than that of conventional concrete (around 2400 Kg/m³). Important advantages are associated with the use of light concrete, for example, reduced weight and size of building structures, reduced foundation-ground load, reduced seismic actions. Light or lightened concrete is prepared by replacing common aggregates with light aggregates, such as expanded clay, pearlite, vermiculite, rottenstone, lapilli, polystyrene. However, only few light aggregates are suitable for the production of structural concretes, i.e. concrete with compression cubic resistance higher than 15 N/mm².

### DESCRIPTION OF THE INVENTION

It has now been found that a lightweight artificial aggregate consisting of PET granules provides structural and non structural concrete with properties of lightness, workability, mechanical resistance, durability and low thermal conductivity.

The lightweight artificial aggregate according to the invention is composed of PET granules, which can be coated with fine or coarse sand to improve the adherence between grains and mortar.

In the preparation of the aggregate, PET material from different sources, including recycled PET bottles, is reduced into flakes which are then subjected to a thermal and mechanical process thus forming a resistant, light aggregate. This aggregate, which will be referred to as “non-sanded” lightweight PET aggregate, can be used as such in the preparation of non-structural concrete. In alternative, the surface of the PET aggregate is covered or coated with sand, thus forming a “sanded” aggregate suitable for the manufacture of structural concrete.

In a preferred embodiment of the invention, sanded and non-sanded PET aggregates are produced as follows. A defined amount of PET flakes—depending on the desired granulometry and the volume mass of the granule—is placed in a ventilated oven and heated to a temperature of 250-260° C. for a time sufficient for flakes to curl and for their surface to soften, at the same time applying a vibratory and rotational mechanical movement to increase the number of contacts between flakes. When heating is ended, the aggregated flakes are subjected to a controlled pressure that gives them a spheroid shape. The applied compression strength determines the final resistance of the grain. It is important that during the process, PET does not reach complete melting. The thus produced non-sanded PET aggregate can be further processed to obtain a sanded aggregate. In this case, PET granules are subjected to surface flaming and rolled on fine or coarse sand to obtain uniform coating of the granules.

Sanded and non-sanded aggregates are separated by size with an appropriate sieve. The aggregates can have different sizes, ranging from 1 to 40 mm, which correspond to different resistance classes. Depending on the compression strength applied during granule formation, the number and size of the empty spaces within grains change and the mechanical resistance changes accordingly.

The aggregates are classified as i) fine, when the size does not exceed 3 mm, ii) medium, between 3 and 7 mm, and iii) coarse, over 7 mm.

The heap weight of the PET aggregate depends on the granulometry and compression strength, but it is generally comprised between 100 and 1100 Kg/m³. By way of example, an aggregate in sanded PET with coarse size between 17 and 20 mm and subjected to low compression degree, has a heap weight of approximately 520 Kg/m³.

The lightweight artificial aggregate of the invention allows to prepare concrete with good mechanical resistance and a lower weight/volume ratio (<2000 Kg/m³) than conventional concrete. The concrete produced from PET aggregates possesses insulating properties due to the low thermal conductivity of PET. Examples of concrete/materials for building industry that can be produced from lightweight sanded-PET artificial aggregates include, but are not limited to, lightened structural concrete and concrete of the SCC type (Self-Compacting Concrete). Non-sanded aggregates are preferably used in the preparation of non-structural concrete as well as loose material for fillings with thermal and acoustic insulation properties, especially for aggregates with big grain size.

Since the aggregates can be produced from recycled materials, especially from recycled plastics such as PET bottles, their use in the preparation of concrete according to the present invention may provide an important contribution to waste disposal thus reducing the environmental impact of plastic wastes.

### DESCRIPTION OF THE FIGURES

FIG. 1: granule of the artificial aggregate in “sanded PET”

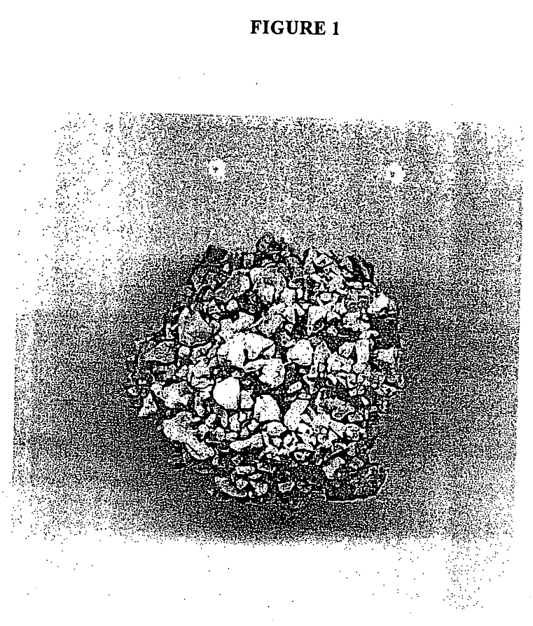

FIG. 2: Coarse-size aggregate

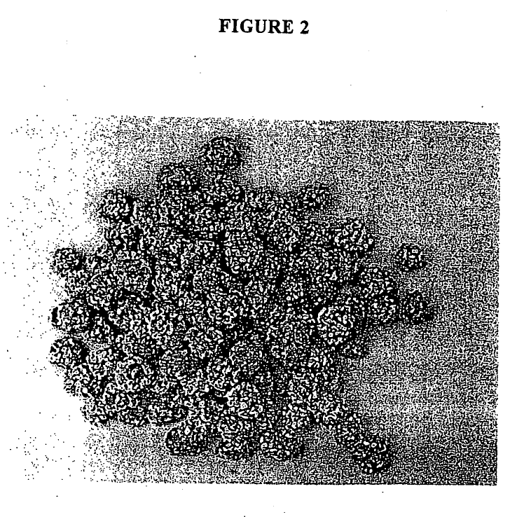

FIG. 3: PET “flakes” used in the production of the artificial aggregate

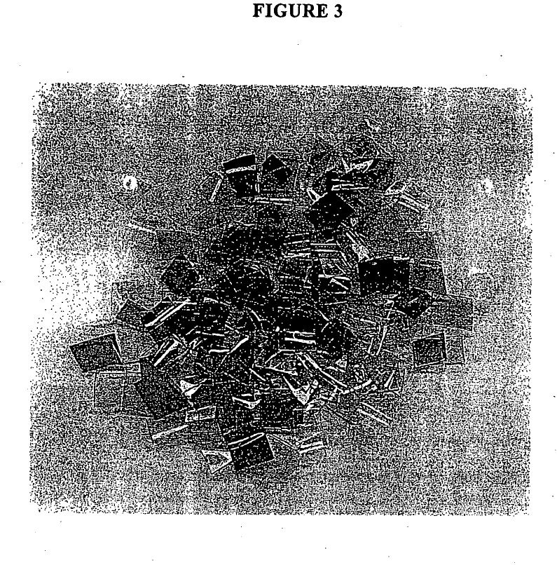

FIG. 4: Curled flakes

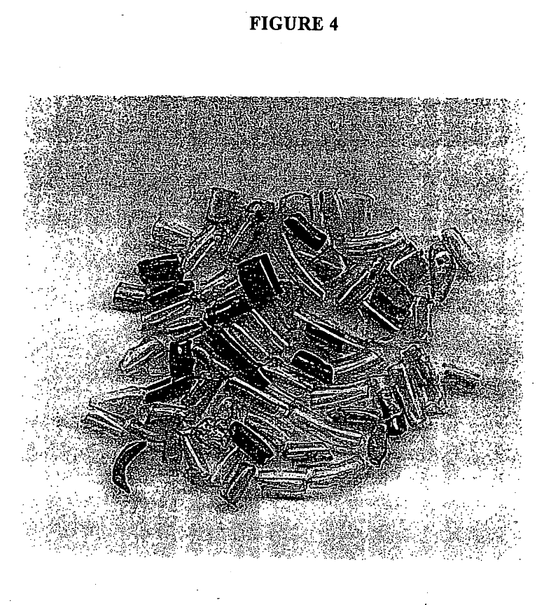

FIG. 5: PET granules after forming

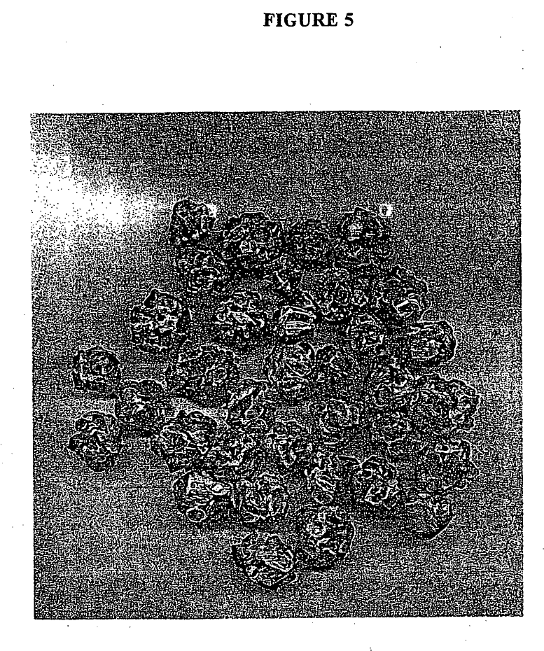

### TABLES

Lightweight Structural Concrete

TABLE 1
Properties of sanded lightweight PET aggregate

| | |
|---|---|
| Diameter (mm) | 13-20 |
| Heap weight (Kg/m³) | 520 |
| Grain weight (Kg/m³) | 1316 |
| Surface | sanded |
| Water absorption | negligible |

The used formula is reported in table 2 showing that the most unfavourable condition has been chosen: a small quantity of concrete, a high ratio water/cement, a PET volume percentage equal to the 60% of the entire aggregate.

TABLE 2
Mix Design of the structural concrete lightened with
light artificial aggregate in “sanded” PET

| CEM I 42.5 R | 285 | Kg/m³ |
|---|---|---|
| Aggregate PET (13-20 mm) | 557 | Kg/m³ |
| Crusher sand | 761 | Kg/m³ |
| Water | 170 | l/m³ |
| Super-plasticizer | 2.9 | l/m³ |
| Ratio water/cement | 0.6 | |
| Consistence | S5 | |
| Volume mass | 1780 | Kg/m³ |
| Compression resistance (28 dd) | 27 | Mpa |

Lightweight Aggregate of Big Grain Size for Fillings

TABLE 3
Properties of lightweight PET aggregate.

| | |
|---|---|
| Diameter (mm) | 15-25 |
| Heap weight (Kg/m³) | 400 |
| Surface | not sanded |
| Water absorption | Negligible |

The material is resistant, light, non conductive, invariable in time; it resists distorsion also at high temperatures (not far from fusion point) and does not go rotten. If burned, it does not emit toxic gases.

1. An aggregate of PET (polyethylenterephtalate) granules for the manufacture of lightened concrete.

2. An aggregate according to claim 1, wherein the granules are in the form of flake aggregates.

3. An aggregate according to claim 2, wherein the flakes are produced from recycled PET bottles.

4. An aggregate according to claim 1, which is coated with sand.

5. A process for the preparation of the aggregate according to claim 1, which comprises the following steps:
a) reducing PET material into flakes;
b) subjecting the PET flakes to a thermal and mechanical process to form flake aggregates;

6. A process for the preparation of the aggregate according to claim 4, which comprises the following steps:
a) reducing PET material into flakes;
b) subjecting the PET flakes to a thermal and mechanical process to form flake aggregates;
c) coating PET flake aggregates with sand.

7. A process according to claim 6, which comprises:
a) providing PET flakes;
b) placing the flakes in a ventilated oven and heating to a temperature of 250° C.-260° C., applying a vibratory and rotational mechanical movement, to obtain flake aggregates;
c) compressing flake aggregates from step (b), to obtain PET granules;

8. A process according to claim 7, which comprises
a) providing PET flakes;
b) placing the flakes in a ventilated oven and heating to a temperature of 250° C.-260° C., applying a vibratory and rotational mechanical movement, to obtain flake aggregates;
c) compressing flake aggregates from step (b), to obtain PET granules;
d) subjecting PET granules to surface flaming and rolling the same on sand to obtain aggregates of coated PET granules;

9. PET aggregate obtainable by the process of claim 7.

10. The use of a PET aggregate for the preparation of structural or non-structural concrete or materials for building industry.

11. The use according to claim 10 of a PET aggregate coated with sand.

12. Lightened concrete or materials for building industry containing a PET aggregate of claim 1.

13. A concrete or material for building industry according to claim 13, which is structural and non-structural concrete, self-compacting concrete and thermally and acoustically insulated filling material.
